(19) United States
(12) Patent Application Publication
(10) Pub. No.: US 2005/0138547 A1
(43) Pub. Date: Jun. 23, 2005

(54) Managing address identification information in a software application

(75) Inventors: Emad E. Muhanna, Toronto (CA); Daniel Alan Rose, Markham (CA); Baldev Singh Soor, Markham (CA)

Correspondence Address: Leslie A. Van Leeuwen;International Business Machines, Intellectual Property Law, 11400 Burnet Road, Austin, TX, 78758, US

(73) Assignee: INTERNATIONAL BUSINESS MACHINES CORPORATION, ARMONK, NY (US)

(21) Appl. No.: 10/855,727

(22) Filed: May 27, 2004

(30) Foreign Application Priority Data
Dec. 19, 2003 (CA) 2453772

(51) Int. Cl. G06F 15/00

(52) U.S. Cl. 715/513

(57) ABSTRACT

A method, system, program product and signal bearing medium for managing address identification information in accordance with predetermined preferences for a software application in an information handling system. There are provisions for receiving data input containing the address identification, from which is generated an XML file representation of the address identification. Mapping of the XML file representation is performed to create a sorted map according to a selected one of the predetermined preferences. Formatting the sorted map to create a tag based output representation of the address identification for the software application use is then performed to provide a representation of the address identification in accordance with a selected predetermined preference.

### FIELD OF THE INVENTION

This present invention relates generally to formatting of information in an information handling system and more particularly to formatting address identification information in accordance with predetermined preferences in an information handling system.

### BACKGROUND OF THE INVENTION

Globalizing web-based software applications mandates support for country specific name and address formats, interchangeably referred to as address identification information throughout. Basic globalization support, as defined by IBM and many other major software development companies, includes support for a country's keyboard, for a country's character set and code pages, for correct entry, processing and presentation of cultural formatting (i.e. a countrys numeric format, monetary format, date and time formats, and calendar format), as well as support for bidirectional scripts (right-to-left and left-to-right), for cultural sort, and for the Euro currency.

In most object-oriented programming languages, cultural information such as date/time format, currency format, number format, collation rules, and text boundary rules can be obtained from locale-sensitive classes. The locale-sensitive classes are smart classes that change the function results to best meet the current language and country environment. This change in the behavior based on the locale and is designed to produce expected results in accordance with the predetermined preferences such as those provided by the locale specifications. Name and address formatting is much more complicated than other cultural formatting and does not have the same locale-sensitive classes that software developers can use while globalizing their software application (such as address forms, address information and other related information). Software developers have, therefore, responsible for implementing their own name and address formatting scheme.

While the output of the locale-sensitive date, time, currency and number formatting operations is a few alpha-numeric characters that can be imbedded any where in an application's content (such as a graphical user interface (GUI) page), the output of name and address formatting ranges from a web-based address form with several translatable tags and GUI objects to a few lines of textual address on a shipping confirmation page (i.e. mailing label format). Thus, any name and address formatting scheme should separate the formatting process from the presentation processes.

Existing solutions typically do not provide complete end-to-end solutions having generation, formatting and presentation services, and they typically have one or more of the following disadvantages:

The different address formats are hardcoded through the use of “if-else” logic statements:

if (loc.equals(″ja_JP″)||loc.equa1s(″ko_KR″)||loc.equals(″zh_CN″)||loc.equals(″zh_TW″))

{
if (loc.equals(″ja_JP″))

{
pageContext.getOut( ).print(strLastName + strFirstName + ″<br>″);
pageContext.getOut( ).print(strCountry + ″ ″ + strZipCode + ″<br>″);
pageContext.getOut( ).print(strState + ″ ″ + strCity + ″<br>″);
pageContext.getout( ).print(strAddrLnl + ″ ″ + strAddrLn2 +″<br>″);
}

else if (loc.equals(″ko_KR″))}

The formatting and presentation phases are not clearly separated (i.e. mixed together in the same file or segment of code) making formatting and presentation implementation specific and impossible for one component developers to re-use the work of other component developers.

The fact that different address formats are required for different countries but developers typically support one set of address formats for all countries. Developers should not impose one set of address formatting to work for all. For example, in some countries it is mandatory to include the ZIP code (and it must be identified correctly as well), while in some countries it is called POSTAL CODE but in other countries this notion is completely absent. In another example, not all countries use the name/street/city/province/country address model; some use variations on this and some use the country/province/city/street/name model.

The ability to have optional items and discretionary address lines might not be implemented or widely supported.

What is required therefore is a more flexible efficient means to provide name and address formatting support for use by software applications.

### SUMMARY OF THE INVENTION

A method, system and program product is provided for formatting address identification information in accordance with the predetermined preferences such as those of cultural specifications of users of a software application in an information handling system. Support is provided for name and address formatting, also referred to as address identification information for web-based applications using Extensible Markup Language (XML), Java and Java Server Pages (JSP) TagLibs (TagLibs are an extension of JavaServerPages introducing custom XML tags which are interpreted by Java classes at execution time) in a stage approach.

In a first stage, name and address format definition attributes in XML format (create definition stage) are created. In the next stage, the definition attributes in XML format are parsed to create an instance of the name and address attributes as a sorted map in the memory of the system (parse definition and create instance stage). Then in a third stage the presentation layer is encapsulated by parsing the name and address instance generated in the previous stage, and using that instance to generate a final formatted name and address form or label (parse instance stage).

An embodiment of the present invention provides a complete end-to-end solution covering generation, formatting and presentation that clearly separates the three stages of the address formulating process making it fully extensible. For example, the presentation stage can be implemented using different technologies according to the nature of the object being formatted (i.e. the sorted map could be used to either construct an HyperText Markup Language (HTML) address form or a standard mailing label by recursively reading each line and displaying each element of the address according to the order specified). In another example, presentation logic could be encapsulated in JSP custom tags and/or JavaBeans.

Some developers or implementers might want to avoid having tags that generate HTML as in an embodiment of the present invention. An alternative to the address format tag is to have a “JSP include file” for each locale that creates and uses the sorted map of the second stage. The included JSP can formulate the correct name of the file to include using a base name (e.g. “Address”) plus the locale name (e.g. “en_US”) and then use <jsp:include> to include it.

The first stage (create definition stage) can also be accomplished through manual creation of an XML file as in the case of using an editor or automated through the creation and use of a GUI tool that generates the definition file after capturing input via prompts from a user. Both are examples of differing implementations to provide input data. In another example an existing address label may be scanned or read into an XML file as a means of capturing information on which to build later locale based formats. Scanned input may require further touch-up but it may provide a faster means of data acquisition. A typical information handling system would have such scanning, printing and editing facilities available.

In one embodiment of the invention, there is provided a method for managing address identification information in accordance with predetermined preferences for a software application in an information handling system, comprising, receiving data input containing said address identification, generating an XML file representation of said address identification, mapping said XML file representation to create a sorted map according to a selected one of said predetermined preferences and formatting said sorted map to create a tag based output representation of said address identification for said software application use.

In another embodiment of the invention, there is provided a computer system for managing address identification information in accordance with predetermined preferences for a software application in an information handling system, said computer system comprising, a receiver adapted to receive data input containing said address identification, a generator to generate an XML file representation of said address identification, a mapper to create a sorted map according to a selected one of said predetermined preferences of said XML file representation, and a formatter for formatting said sorted map to create a tag based output representation of said address identification for said software application use.

In another embodiment of the invention, there is provided a computer program product having a computer readable medium tangibly embodying computer readable program code for instructing a computer to perform a method for managing address identification information in accordance with predetermined preferences for a software application in an information handling system, comprising, receiving data input containing said address identification, generating an XML file representation of said address identification, mapping said XML file representation to create a sorted map according to a selected one of said predetermined preferences and formatting said sorted map to create a tag based output representation of said address identification for said software application use.

In another embodiment of the invention, there is provided a computer program product having a computer readable medium tangibly embodying computer readable program code for instructing a computer to provide the receiver, generator, mapper and formatter means of a computer system for managing address identification information in accordance with predetermined preferences for a software application in an information handling system, said computer system comprising, a receiver adapted to receive data input containing said address identification, a generator to generate an XML file representation of said address identification, a mapper to create a sorted map according to a selected one of said predetermined preferences of said XML file representation, and a formatter for formatting said sorted map to create a tag based output representation of said address identification for said software application use.

In yet another embodiment of the present invention there is provided a signal bearing medium having a computer readable signal tangibly embodying computer readable program code for instructing a computer to perform a method for managing address identification information in accordance with predetermined preferences for a software application in an information handling system, comprising, receiving data input containing said address identification, generating an XML file representation of said address identification, mapping said XML file representation to create a sorted map according to a selected one of said predetermined preferences and formatting said sorted map to create a tag based output representation of said address identification for said software application use.

In yet another embodiment of the present invention there is provided a signal bearing medium having a computer readable signal tangibly embodying computer readable program code for instructing a computer to provide the receiver, generator, mapper and formatter means of a computer system for managing address identification information in accordance with predetermined preferences for a software application in an information handling system, said computer system comprising, a receiver adapted to receive data input containing said address identification, a generator to generate an XML file representation of said address identification, a mapper to create a sorted map according to a selected one of said predetermined preferences of said XML file representation, and a formatter for formatting said sorted map to create a tag based output representation of said address identification for said software application use.

Other aspects and features of the present invention will become apparent to those of ordinary skill in the art upon review of the following description of specific embodiments of the invention in conjunction with the accompanying figures.

### BRIEF DESCRIPTION OF THE DRAWINGS

Preferred embodiments of the invention will now be described, by way of example, with reference to the accompanying drawings, in which:

FIG. 1 is a hardware overview of a computer system, in support of an embodiment of the present invention;

FIG. 2 is a schematic diagram of components in an embodiment of the present invention operating in an environment as shown in FIG. 1.

Like reference numerals refer to corresponding components and steps throughout the drawings. It is to be expressly understood that the description and the drawings are only for the purpose of illustration and as an aid to understanding, and are not intended as a definition of the limits of the invention.

### DETAILED DESCRIPTION

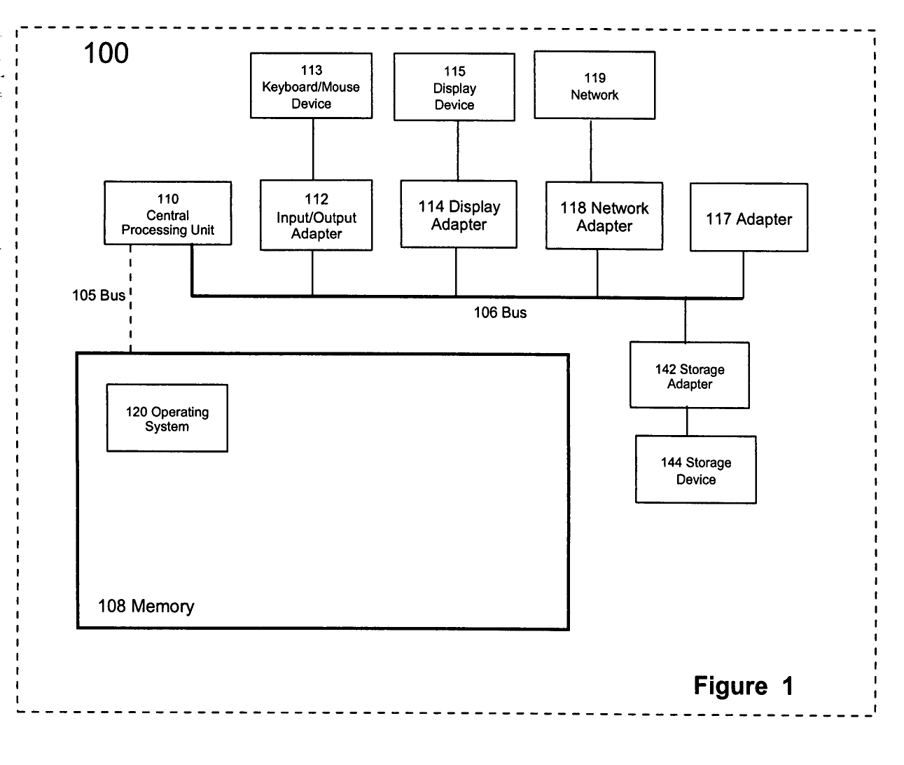

FIG. 1 depicts, in a simplified block diagram, a computer system 100 suitable for implementing embodiments of the present invention. Computer system 100 has processor 110, which is a programmable processor for executing programmed instructions stored in memory 108. Memory 108 can also include hard disk, tape or other storage media. While a single CPU is depicted in FIG. 1, it is understood that other forms of computer systems can be used to implement the invention. It is also appreciated that the present invention can be implemented in a distributed computing environment having a plurality of computers communicating via a suitable network 119.

CPU 110 is connected to memory 108 either through a dedicated system bus 105 and/or a general system bus 106. Memory 108 can be a random access semiconductor memory for storing application data for processing such as that in a database partition. Memory 108 is depicted conceptually as a single monolithic entity but it is well known that memory 108 can be arranged in a hierarchy of caches and other memory devices. FIG. 1 illustrates that operating system 120 may reside in memory 108.

Operating system 120 provides functions such as device interfaces, memory management, multiple task management, and the like as known in the art. CPU 110 can be suitably programmed to read, load, and execute instructions of operating system 120. Computer system 100 has the necessary subsystems and functional components to implement selective program tracing functions such as gathering trace records and historical data as will be discussed later. Other programs (not shown) include server software applications in which network adapter 118 interacts with the server software application to enable computer system 100 to function as a network server via network 119.

General system bus 106 supports transfer of data, commands, and other information between various subsystems of computer system 100. While shown in simplified form as a single bus, bus 106 can be structured as multiple buses arranged in hierarchical form. Display adapter 114 supports video display device 115, which is a cathode-ray tube display or a display based upon other suitable display technology. The Input/output adapter 112 supports devices suited for input and output, such as keyboard or mouse device 113, and a disk drive unit (not shown). Storage adapter 142 supports one or more data storage devices 144, which could include a magnetic hard disk drive or CD-ROM, although other types of data storage devices can be used, including removable media.

Adapter 117 is used for operationally connecting many types of peripheral computing devices to computer system 100 via bus 106, such as printers, bus adapters, and other computers using one or more protocols including Token Ring, LAN connections, as known in the art. Network adapter 118 provides a physical interface to a suitable network 119, such as the Internet. Network adapter 118 includes a modem that can be connected to a telephone line for accessing network 119. Computer system 100 can be connected to another network server via a local area network using an appropriate network protocol and the network server that can in turn be connected to the Internet. FIG. 1 is intended as an exemplary representation of computer system 100 by which embodiments of the present invention can be implemented. Computer system 100 may also be referred to as an information handling system. It is understood that in other computer systems, many variations in system configuration are possible in addition to those mentioned here.

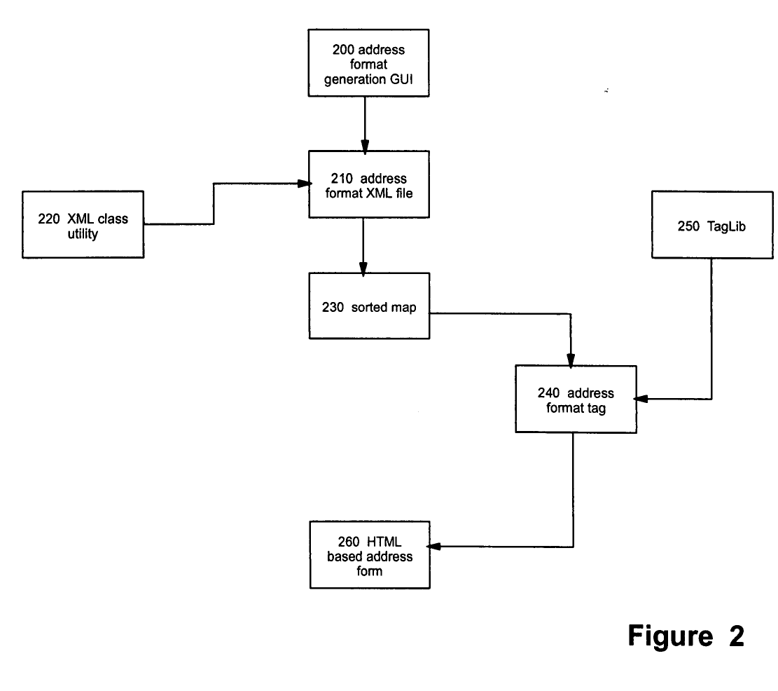

FIG. 2 is a schematic diagram showing the components of an embodiment of the present invention typically implemented on an information handling system as supported by a system as shown in FIG. 1. Component 200 is shown as a GUI tool, such as that supported by display device 115 of FIG. 1, which may be command line or web based that is used to receive input from a user. The input received will contain address identification information to be captured and processed. The receiver of component 200 may also be adapted to receive other forms of information such as that obtained by scanning an image of a shipping label or input from a mailing application such as those associated with word processors and contact managers. Varying adapters and filters may be employed to meets the needs of the input format allowing the information to be read by the receiver of component 200. Component 200 would typically be adapted to receive data input from a variety of sources such as a computer terminal, scanner, file transfer and file copy action or other devices normally used for data input and typically supported by a system such as that shown in FIG. 1. Component 200 is associated with the first stage of the overall name and address management process.

In a first stage the name and address format definition attributes are created in XML format (XML file). This stage is known as the create definition stage. These attributes include, but are not limited to: the locality for which the name and address format is being defined; the number of lines that constitutes an address format; the sequence of elements on each line of the address (for example: LastName, FirstName, and Title must all be written on one line while street address is displayed by itself on a single line); the nature of each attribute, such as being mandatory or optional. (for example the province field is mandatory on a Canadian address form while it is optional for a German address form. With regards to optional parameters, a specification indicates if the parameter should be displayed at all as part of the address form or if it must not be displayed. For example, zip code is optional in some countries where the value provided is used to reduce the delivery effort for delivering a package and the absence of it does not imply that the package will not be delivered. On the other hand, some countries don't have the notion of a zip code and the display of such field on an address form can be very confusing. The nature of the attribute value might be a single value or multiple values. For example, the values of such attributes as country and province are a list of countries and provinces respectively displayed in a dropdown list.

For example, the format of the AddressFormat.xml file in an embodiment of the present invention could be as follows:

<addressFormats>
<en_US>

<line0 elements=″nickName″/>
<line1 elements=″title(optional,multiple),space,firstName,space,
lastName″/>
<line2 elements=″address1,space,address2,space,
address3(optional)″/>
<line3 elements=″city,comma,space,state(multiple)″/>
<line4 elements=″country,comma,space,postalCode″/>
<line5 elements=″phoneNumber″/>

</en_US>
<Ja_JP>

<line0 elements=″nickName″/>
<line1 elements=″title(Optional),lastName,firstName″/>
<line2 elements=″country,postalCode″/>
<line3 elements=″region,city″/>
<line4 elements=″address1,address2,address3″/>
<line5 elements=″phoneNumber″/>

</Ja_JP>
<default>

<line0 elements=″nickName″/>
<line1 elements=″title,lastName,firstName″/>
<line2 elements=″address1,address2,address3″/>
<line3 elements=″city,comma,region″/>
<line4 elements=″country,comma,postalCode″/>
<line5 elements=″phoneNumber″/>

</default>
</addressFormats>

There could be one address format XML file per locale or there could be country specific tags to denote segments of data for a respective country embedded in a common address format XML file.

The address format description can be created manually, generated through a GUI tool or other programmatic means such as scanning input or receiving data from a contact management system. The GUI tool is intended to be used by a user, who will not necessarily have knowledge of Java and XML, to define the address format for a specific country. The user would typically be a customer service representative, business analyst, or store designer. When using the GUI tool, the user will be presented with a set of combo boxes, edit boxes, selection boxes, and other GUI objects as an aid in the definition of the name and address format of a specific country.

Information received in component 200 is then processed using content of component 220 XML class utility. Component 220 is a group of XML utility classes in Java capable of parsing the AddressFormat.xml file just created by component 200 and generating 230 sorted map, an instance in memory of the system. This portion of the process is known as the parse definition and create instance stage. The address instance, 230 sorted map, would typically contain the following information: the locale name (such as ja_JP, en_US,), the locality and region, and a set of address description lines formatted correctly in accordance with the predetermined preferences as specified by the locality. This information is typically stored as key-value pairs where the key being the line number and the value being the elements that constitute each line of the address form in a correct sequence. Also, the values are further mapped as keys to a translation text file to retrieve the elements' translated tags. For example, the key-value pair for Japan would typically be:
locale ja_JP
locality =Japan
line0=nickName
line1=title(Optional),lastName,firstName
line2=address1,address2,address 3
line3=city,comma,region
line4=country,comma,postalcode
line5=phoneNumber

Sorted map 230 could then be used to either construct an HTML based address form 260 or a standard mailing label by recursively reading each line and displaying each element according to the order defined in the key-value pair and the nature of the attribute.

Component 240 defines a JSP AddressFormat custom tag that uses sorted map 230 and generates a formatted address in HTML format, such as HTML-based address form 260, as part of the parse instance stage. A custom tag is a portable and reusable mechanism provided by the JSP technology for defining HTML-like customized and modular functionality to be used in JSP Pages. Custom tags are implemented using Tag Libraries such as TagLib 250 which are imported into the JSP pages using the ‘taglib’ directive. They can be referenced in the page using the prefix defined by this directive. Custom tags are ideal for iterating through a list of data, or for replacing pieces of display related logic. They implement logic similar to the JavaBeans, with one difference being that a bean needs to be first declared and then accessed using ‘get’, ‘set’ methods, whereas tags work with a page by obtaining information passed through their defined parameters when the tag is created. Tags have access to the web container and all the objects available to the JSP pages.

Although the invention has been described with reference to illustrative embodiments, it is to be understood that the invention is not limited to these precise embodiments and that various changes and modifications may be effected therein by one skilled in the art. All such changes and modifications are intended to be encompassed in the appended claims.

1. A method for managing address identification information in accordance with predetermined preferences for a software application in an information handling system, comprising:
receiving data input containing said address identification;
generating an XML file representation of said address identification;
mapping said XML file representation to create a sorted map according to a selected one of said predetermined preferences; and,
formatting said sorted map to create a tag based output representation of said address identification for said software application use.

2. The method of claim 1, wherein receiving data input further comprises receiving data input from a user in the form of said address identification via a graphical user interface.

3. The method of claim 1, wherein receiving data input further comprises receiving data input in the form of said address identification directly into said XML file via an editor.

4. The method of claim 1, wherein said address identification further comprises indicators for: locality, number of lines, element sequences, nature of attribute, number of values per value and conditional process directives.

5. The method of claim 1 wherein said mapping further comprises using Java utility classes, including a parser, to create an instance containing locale name, locality and a set of address description lines formatted according to said locality.

6. The method of claim 1, wherein said formatting further comprises a custom tag using JSP to define HTML output of said address identification.

7. The method of claim 1 wherein receiving data input further comprises a receiver adapted to receive data input by means selected from a group comprising: computer terminal, scanner, file transfer and file copy.

8. A computer system for managing address identification information in accordance with predetermined preferences for a software application in an information handling system, said computer system comprising:
a receiver adapted to receive data input containing said address identification;
a generator to generate an XML file representation of said address identification;
a mapper to create a sorted map according to a selected one of said predetermined preferences of said XML file representation; and
a formatter for formatting said sorted map to create a tag based output representation of said address identification for said software application use.

9. The system of claim 8 wherein said mapper further comprises Java utility classes, including a parser, to create an instance containing locale name, locality and a set of address description lines formatted according to said locality.

10. The system of claim 9, wherein said formatter further comprises a custom tag using JSP to define HTML output of said address identification.

11. The system of claim 10 wherein said receiver is adapted to receive data input from at least one selected from a group comprising: computer terminal, scanner, file transfer and file copy.

12. A computer program product having a computer readable medium tangibly embodying computer readable program code for instructing a computer to perform the method of claim 1.

13. A signal bearing medium having a computer readable signal tangibly embodying computer readable program code for instructing a computer to perform the method of claim 1.

14. A computer program product having a computer readable medium tangibly embodying computer readable program code for instructing a computer to provide the receiver, generator, mapper and formatter means of claim 8.

15. A signal bearing medium having a computer readable signal tangibly embodying computer readable program code for instructing a computer to provide the receiver, generator, mapper and formatter means of claim 8.
